(19) United States
(12) Patent Application Publication
(10) Pub. No.: US 2010/0186942 A1
(43) Pub. Date: Jul. 29, 2010

(54) RETICLE ERROR REDUCTION BY COOLING

(76) Inventors: Alton H. Phillips, East Palo Alto, CA (US); Douglas C. Watson, Campbell, CA (US); Hiromitsu Yoshimoto, Saitama (JP); Noriya Kato, Annaka (JP); Yusaku Uehara, Ageo (JP); Leonard Wai Fung Kho, San Francisco, CA (US)

Correspondence Address: TI Law Group, 2055 Junction Avenue, #205, San Jose, CA, 95131-2116, US

(21) Appl. No.: 12/643,932

(22) Filed: Dec. 21, 2009

Related U.S. Application Data
(60) Provisional application No. 61/146,658, filed on Jan. 23, 2009.

(51) Int. Cl. F25B 49/00; F25B 29/00; F25B 21/02; G03B 27/52

(52) U.S. Cl. 165/253; 165/261; 62/3.2; 355/30

(57) ABSTRACT

Methods and apparatus for cooling a reticle are disclosed. According to one aspect of the present invention, an apparatus for providing top side cooling to a reticle includes a heat exchanger arrangement and an actuator. The heat exchanger arrangement includes a first surface arranged to facilitate heat transfer between the reticle and the heat exchanger arrangement. The heat transfer provides cooling to at least some portions of the reticle. The actuator positions the first surface of the heat exchanger arrangement at a distance over the reticle.

### CROSS-REFERENCE TO RELATED APPLICATION

The instant application claims priority of U.S. Provisional Patent Application No. 61/146,658, filed Jan. 23, 2009, entitled “Reticle Error Reduction by Cooling,” which is incorporated herein by reference in its entirety.

### BACKGROUND OF THE INVENTION

1. Field of the Invention

The present invention relates generally to an apparatus used in lithography systems. More particularly, the present invention relates to systems and method used to cool regions of a reticle to reduce reticle distortion.

2. Description of the Related Art

In the presence of heat, reticles have a tendency to distort. The accuracy with which processes that utilize the reticles are performed is compromised when reticles are distorted. By way of example, the accuracy of masking and/or patterning processes which use reticles may be compromised.

To compensate for heat-related distortion of reticles, some systems add heat to the reticles. That is, some systems add heat to reticles during a patterning process to substantially evenly heat the reticles. By evenly heating the reticles, the effect of thermal distortion of the reticles during patterning may be mitigated.

Adding heat to a reticle that is a part of a system, e.g., a photolithography system, during a patterning process may be problematic, as the addition of heat may have an adverse effect on other portions of the system. For example, the accuracy with which sensors determine positions of stages and the like may be affected, if the sensors are temperature-sensitive. Further, the addition of heat may place additional burdens on appropriate air temperature control systems.

### SUMMARY OF THE INVENTION

The present invention pertains to a system which transfers heat between selected regions on a surface of a reticle and a heat exchanger through conductive heat transfer.

According to one aspect of the present invention, an apparatus for providing top side cooling to a reticle includes a heat exchanger arrangement and an actuator. The heat exchanger arrangement includes a first surface arranged to facilitate heat transfer between the reticle and the heat exchanger arrangement. The heat transfer provides cooling to at least some portions of the reticle. The actuator positions the first surface of the heat exchanger arrangement at a distance over the reticle.

In one embodiment, the heat exchanger arrangement includes a heat exchanger and a removable adapter plate that includes the first surface. In another embodiment, the heat exchanger arrangement includes a heat exchanger, a resistive heater array, and a controller arrangement. Such a resistive heater array defines the first surface, and is controlled by the controller arrangement. In still another embodiment, the heat exchanger arrangement includes a heat exchanger, at least one thermoelectric module (TEM) and a controller arrangement. The TEM defines the first surface, and is controlled by the controller arrangement.

According to another aspect of the present invention, a cooling device suitable for providing top side cooling to a reticle includes a heat exchanger, a sensing arrangement, and a heating arrangement. The heat exchanger being absorbs heat associated with the reticle. The sensing arrangement is configured to obtain at least one temperature associated with a cooling surface. The heating arrangement is coupled to the heat exchanger, and includes a plurality of heating elements and a first arrangement. The first arrangement individually controls each heating element based on the temperature associated with the cooling surface.

According to still another aspect of the present invention, a method for cooling a reticle includes identifying at least one zone associated with the reticle, and determining if a temperature associated with the zone indicates that the zone is to be cooled. The method also includes activating a first heating element associated with the zone if it is determined that the zone is not to be cooled. Activating the first heating element compensates for cooling provided by a heat exchanger. Finally, the method includes cooling the zone using the heat exchanger if it is determined that the at least one zone is to be cooled.

Other aspects of the present invention will become apparent from the following detailed description taken in conjunction with the accompanying drawings which illustrate, by way of example, the principles of some embodiments of the present invention.

### BRIEF DESCRIPTION OF THE DRAWINGS

The invention will be readily understood by the following detailed description in conjunction with the accompanying drawings, in which:

FIG. 1 is a block diagram representation of a system which includes a top side cooling arrangement configured to cool portions of a surface of a reticle in accordance with an embodiment of the present invention.

FIG. 2 is a diagrammatic cross-sectional side-view representation of a system which includes a top side cooling arrangement in accordance with an embodiment of the present invention.

FIG. 3A is a block diagram representation of a system which includes a top side cooling arrangement with a resistive heater arrangement configured to cool portions of a surface of a reticle in accordance with an embodiment of the present invention.

FIG. 3B is a diagrammatic representation of a resistive heater arrangement, e.g., resistive heater arrangement 332 of FIG. 3A, in accordance with an embodiment of the present invention.

FIG. 4 is a diagrammatic cross-sectional side-view representation of a system which includes a top side cooling arrangement with a resistive heater in accordance with an embodiment of the present invention.

FIG. 5 is a perspective cut-away representation of a top side cooling device in accordance with an embodiment of the present invention.

FIG. 6 is a process flow diagram which illustrates a method of providing top side cooling to a reticle which includes closed-loop distortion control in accordance with an embodiment of the present invention.

FIG. 7 is a perspective representation of a portion of a top side conductive cooling device in accordance with an embodiment of the present invention.

FIG. 8 is a diagrammatic representation of an array of thermoelectric coolers or chips (TECs) which are a part of a top side conductive cooling device in accordance with an embodiment of the present invention.

FIG. 9 is a diagrammatic representation of TECs in relation to a heat exchanger (HEX) in accordance with an embodiment of the present invention.

FIG. 10 is a diagrammatic representation of a photolithography apparatus in accordance with an embodiment of the present invention.

FIG. 11 is a process flow diagram which illustrates the steps associated with fabricating a semiconductor device in accordance with an embodiment of the present invention.

FIG. 12 is a process flow diagram which illustrates the steps associated with processing a wafer, i.e., step 1104 of FIG. 11, in accordance with an embodiment of the present invention.

FIG. 13 is a block diagram representation of a system which includes a top side cooling arrangement configured to cool portions of a surface of a reticle by substantially direct contact in accordance with one embodiment of the present invention.

FIG. 14 is a block diagram representation of a system which includes a top side cooling arrangement configured to cool portions of a surface of a reticle by substantially direct contact in accordance with another embodiment of the present invention.

FIG. 15 is a block diagram representation of a spacer suitable for use with a top side cooling arrangement in accordance with an embodiment of the present invention.

FIG. 16 is a process flow diagram which illustrates a method of providing top side cooling to a reticle which includes open-loop distortion control in accordance with an embodiment of the present invention.

### DETAILED DESCRIPTION OF THE INVENTION

Example embodiments of the present invention are discussed below with reference to the various figures. However, those skilled in the art will readily appreciate that the detailed description given herein with respect to these figures is for explanatory purposes, as the invention extends beyond these embodiments.

Reticles used in exposure processes often suffer distortion in the presence of heat. When reticles are distorted, the accuracy with which some processes that utilize the reticles are performed may be compromised. While optics may be used to compensate for some reticle distortions, some distortions may not be corrected using optics. Hence, substantially minimizing the distortion in reticles that is due to heat may improve the accuracy of processes performed using the reticles.

Heat may be removed from the reticle by convection or conduction, in one embodiment, by providing a cooling mechanism that is configured to cool a top side of a reticle. By cooling the top side of a reticle, as for example during a wafer exchanger process or a scanning process, the effects of heat on the reticle may be minimized. A top side cooling device may be arranged such that when the device is brought to within a particular distance from a top of the reticle, heat is transferred from the top of the reticle to the device, e.g., to a heat exchanger associated with the device.

A top side cooling device may be arranged to provide substantially the same amount of cooling to all areas of a top side of a reticle. Alternatively, a top side cooling device may effectively be a multi-zone device which may be configured to provide cooling, e.g., different amounts of cooling, to selected portions of the reticle while not providing cooling to other portions of the reticle. For example, a top side cooling device may provide cooling to portions of the reticle from which heat is to be removed.

It should be appreciated that in addition to compensating for thermal distortion in a reticle, a top side cooling device may also be used to intentionally distort a reticle. By way of example, a top side cooling device may be used to distort a reticle in such a way as to compensate for lens distortion. A top side cooling device may also be used to intentionally distort a reticle to improve an overlay between multiple images using at least two different reticles, e.g., in a double patterning exposure process.

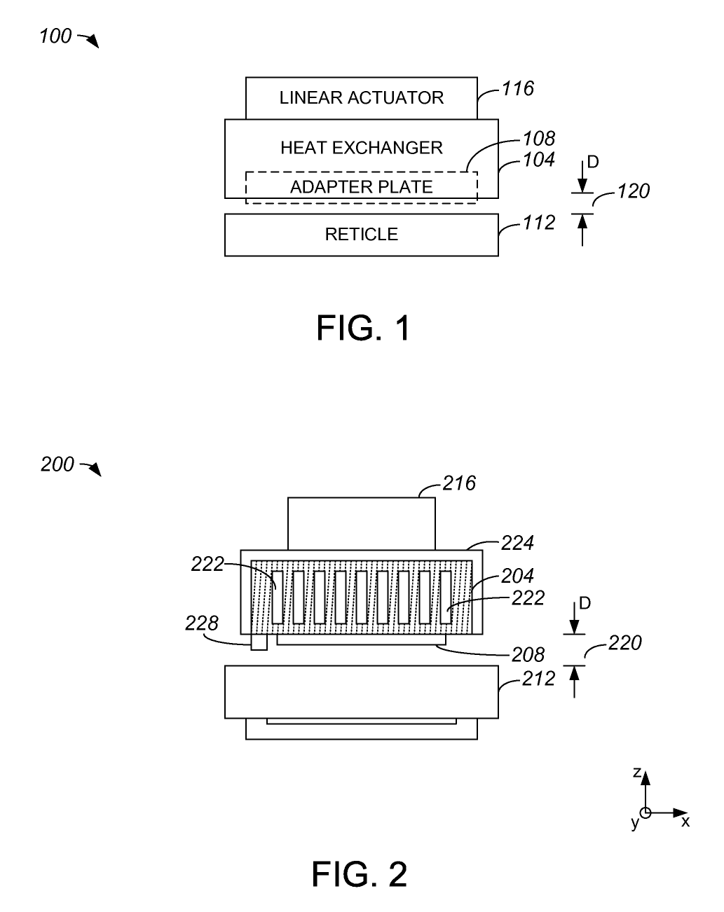

Referring initially to FIG. 1, a system that includes a top side cooling arrangement configured to cool portions of a surface of a reticle in accordance with an embodiment of the present invention. A system 100, which may be included as part of any suitable stage apparatus, includes a reticle 112. Reticle 112 is typically positioned on a stage (not shown), e.g., a reticle scanning stage.

To remove heat from reticle 112, reticle 112 may be positioned at a distance ‘D’ 120 from a heat exchanger 104 such that heat exchanger 104 may effectively obtain heat from reticle 112 substantially without coming into contact with reticle 112. Distance ‘D’ 120 may vary widely. For instance, distance ‘D’ 120 may be in the range of between approximately 0.1 micrometers (μm) and approximately thirty μm, as for example between approximately ten μm and approximately thirty μm. In one embodiment, distance ‘D’ 120 may be approximately 20 μm. It should be appreciated that in some instances, e.g., when asperities are used to establish distance ‘D’ 120, distance ‘D’ 120 may be in the range of between approximately 0.1 μm and approximately five μm. Heat exchanger 104 may be any suitable heat exchanger, as for example a liquid-cooled copper heat exchanger. Heat exchanger 104 is typically relatively cold, although it should be appreciated that the temperature of heat exchanger 104 may generally vary. Heat exchanger 104 may be cooled to between approximately five degrees Celsius and approximately fifteen degrees Celsius or, more preferable, to between approximately fifteen degrees Celsius and between approximately twenty five degrees Celsius.

Heat exchanger 104 may be cooled internally, as for example by a flowing liquid. Heat exchanger 104 may include resistive heating elements arranged to increase the temperature of heat exchanger 104 above the temperature of a cooling liquid. Alternatively, heat exchanger 104 may include thermoelectric chips (TECs) that are arranged to increase or decrease the heat exchanger temperature above or below the temperature of a cooling liquid. It should be appreciated that the terms thermoelectric chips, thermoelectric coolers, and thermoelectric modules may be used substantially interchangeably. In general, thermoelectric chips, thermoelectric coolers, and thermoelectric modules are known as Peltier heat pumps.

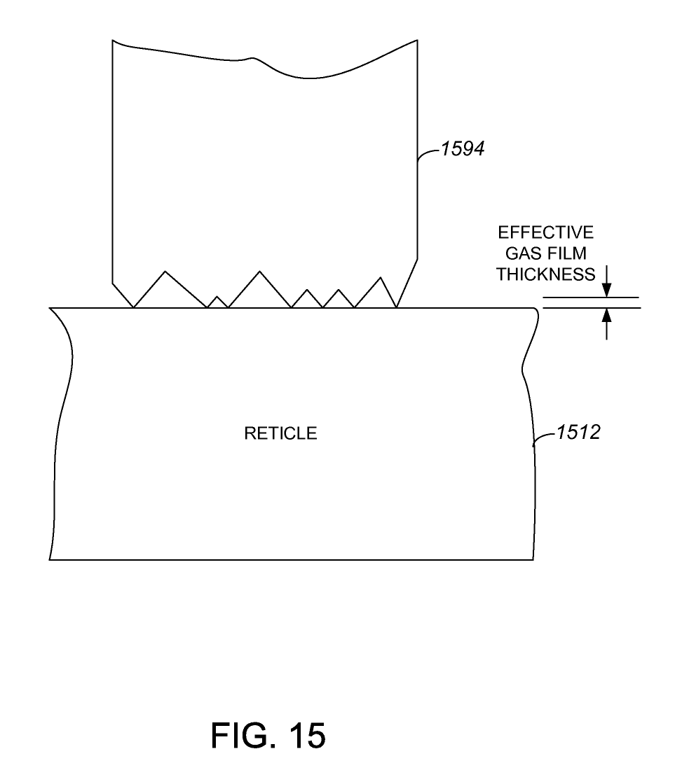

Heat exchanger 104 may include an optional adapter plate 108 which may be arranged to be approximately the same size as a mask pattern (not shown) on reticle 112. In one embodiment, optional adapter plate 108 may be configured to substantially complement the mask pattern, e.g., such that a surface of adapter plate 108 is effectively non-flat. In general, however, adapter plate 108 does not need to be non-flat, and does not need to complement the mask pattern. When adapter plate 108 is non-flat, substantially microscopic asperities in the surface of adapter plate may effectively act as spacer elements arranged to maintain distance ‘D’ 120, as will be discussed below with respect to FIG. 15. Optional adapter plate 108 may be removable such that heat exchanger 104 may remove heat from reticle 112 both with and without adapter plate 108.

In general, reticle 112 may be positioned at distance ‘D’ 120, e.g., substantially underneath heat exchanger 104, at any suitable time. Reticle 112 may be positioned at distance ‘D’ 120 from heat exchanger 104 while reticle 112 is substantially stationary, as for example during a wafer exchange process when reticle 112 is effectively not in use. Alternatively, reticle 112 may be positioned at distance ‘D’ 120 from heat exchanger 104 while reticle 112 is moving, e.g., during scanning.

System 100 may include an actuator 116, e.g., a linear actuator, that may move heat exchanger 104. Actuator 116 may be configured to position heat exchanger 104 at distance ‘D’ 120 from reticle 112 as needed to remove heat from reticle 112, and to remove heat exchanger 104 from the vicinity of reticle 112 when heat removal is not needed. In general, actuator 116 may be used to effectively force heat exchanger 104 and reticle 112 substantially together, while a spacer (not shown) may be used to establish distance ‘D’ 120. Such a spacer (not shown) may be attached to adapter plate 108 or to heat exchanger 104. It should be understood that for an embodiment in which reticle 112 may be relatively quickly moved out of the effective range or heat exchanger 104, e.g., by a reticle stage (not shown) which has a sufficient stroke, actuator 116 may not be needed.

Any amount of heat or, energy, may effectively be removed from reticle 112 by heat exchanger 104. The amount of heat transferred, as for example through conductive heat transfer, may vary based on factors including, but not limited to including, an initial temperature of heat exchanger 104, a size of distance ‘D’ 120, a length of time reticle 112 remains at distance ‘D’ 120 from heat exchanger 104, and the initial temperatures associated with a cooling surface. In one embodiment, system 100 may be configured such that when distance ‘D’ 120 is approximately twenty μm, approximately seventy Joules may be removed from reticle 112 in approximately one second. It should be appreciated that as distance ‘D’ 120 becomes smaller, faster cooling times are possible and/or higher heat exchanger temperatures may be used.

Temperatures are generally obtained such that it may be determined how much heat is to be added or removed from reticle 112 to achieve a desired corrective reticle distortion. The desired corrective reticle distortion may be determined through simulation and/or empirically.

With reference to FIG. 2, a diagrammatic cross-sectional side-view representation of one system which includes a top side cooling arrangement in accordance with an embodiment of the present invention. A system 200 includes a reticle 212 that is positioned at a distance ‘D’ 220 from a heat exchanger arrangement 204 during a top side cooling process, or a process intended to remove heat from reticle 212. It should be appreciated that heat transfer between heat exchanger arrangement 204 and reticle 212 may either be conductive heat transfer. An actuator 216 is arranged to move heat exchanger arrangement 204 such that heat exchanger arrangement 204 may be positioned as appropriate relative to reticle 212.

Heat exchanger arrangement 204 may be formed from any suitable material, e.g., copper or aluminum, and includes an adapter plate 208, although it should be appreciated that adapter plate 208 may be optional. An evacuation groove (not shown) may be formed substantially around the perimeter of heat exchanger arrangement 204 to effectively minimize interactions between heat exchanger arrangement 204 and an ambient environment.

Microchannels 222 may be included in heat exchanger arrangement 204 such that a coolant may flow through heat exchanger arrangement 204. Microchannels 222 facilitate the removal of heat that is transferred from reticle 212 to heat exchanger arrangement 204.

In the described embodiment, heat exchanger arrangement 204 is at least partially covered by insulation 224. Insulation 224 is generally arranged to substantially prevent the temperature of heat exchanger arrangement 204 from affecting other components (not shown) in system 200. Insulation 224 may be configured as a removable shield that substantially minimizes interactions between heat exchanger arrangement 204 and an ambient environment.

A gap sensor 228 is used to effectively collect information relating to the space between heat exchanger arrangement 204 and reticle 212, i.e., the space which has a desired height substantially equal to distance ‘D’ 220. The information gathered by gap sensor 228 may include the actual height of the space and the temperature within the space. Gap sensor 228 is generally used to measure distance ‘D’ 220.

Different adapter plates may be used to accommodate various sizes of reticle patterns. As such, adapter plate 208 may be switched out for a different adapter plate in order to accommodate a particular reticle 212 and, hence, a particular cooling region. Different adapter plates may be sized to accommodate differently sized cooling regions. In lieu of using different adapter plates, a multi-zone resistive heater array may be used in conjunction with a heat exchanger to effectively control the size of a cooling region. Such a multi-zone resistive heater array may enable various zones to provide cooling, while allowing other zones not to provide cooling. That is, multi-zone cooling may be provided. By way of example, zones which are not to provide cooling may effectively be heated to substantially compensate for cooling provided by a heat exchanger.

In one embodiment, a heat exchanger may be cooled to a temperature that is cooler than needed to effectively remove heat from areas of a reticle. That is, a heat exchanger may be overcooled. For example, heat exchanger may be cooled to a temperature of approximately five degrees Celsius, and then resistive heaters may be used to effectively raise the cooling temperature provided to the reticle to approximately ten degrees Celsius. Further, some resistive heaters may be activated to generate heat at higher temperatures than other resistive heater. For instance, to provide less cooling, a resistive heater may be activated to generate heat at a higher temperature. Alternatively, to provide more cooling, the resistive heater may either be unactivated, or may be activated to generate heat at a lower temperature.

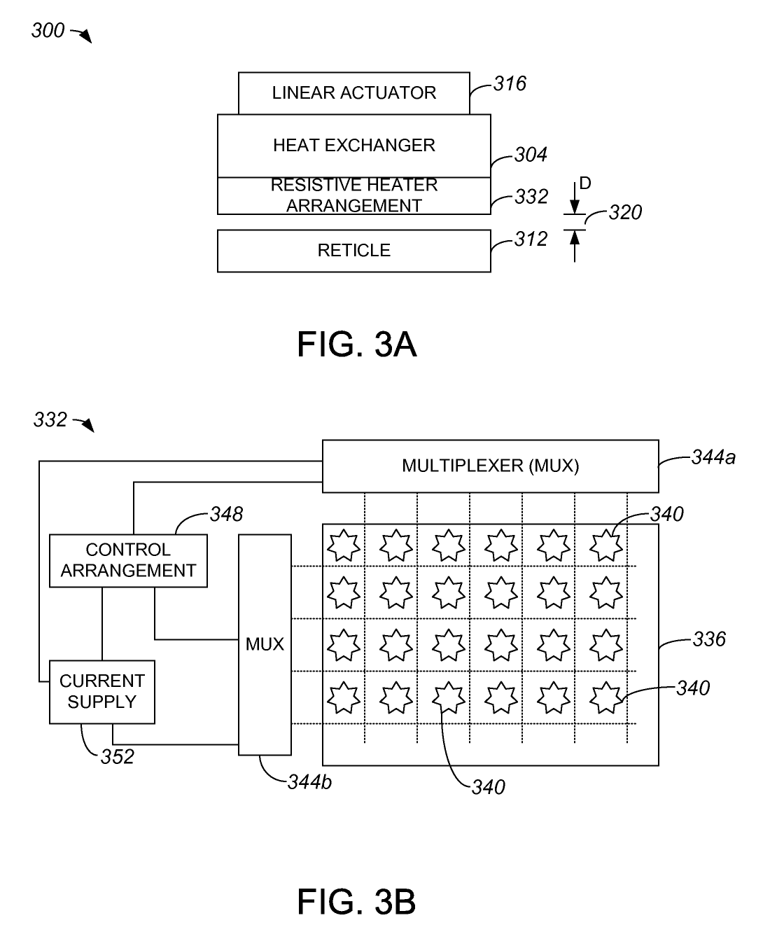

FIG. 3A is a block diagram representation of a system which includes a top side cooling arrangement with a resistive heater arrangement configured to cool portions of a surface of a reticle in accordance with an embodiment of the present invention. A system 300 includes a heat exchanger 304 that is coupled to a resistive heater arrangement 332. When a reticle 312 is to be cooled, or when at least some portions of reticle 312 are to be cooled, a linear actuator 316 may move heat exchanger 304 and resistive heater arrangement 332 to within approximately a distance ‘D’ 320 from a surface of reticle 312. In one embodiment, distance ‘D’ 320 may be approximately 20 μm, although it should be appreciated that distance ‘D’ 320 may generally vary widely. Distance ‘D’ 320 may be maintained by a spacer (not shown) that is attached to heat exchanger 304 or to resistive heater arrangement 332.

Heat exchanger 304 may be a liquid cooled heat exchanger that is formed from a relatively low thermally conductive material. Heat exchanger 304 may be formed from, but is not limited to being formed from, a material such as fused silica, Nexcera, and/or glass. The temperature of heat exchanger 304 is generally maintained at between approximately five degrees Celsius and approximately fifteen degrees Celsius, as for example at approximately twelve degrees Celsius, although it should be appreciated that the temperature at which heat exchanger 304 is preferably maintained may vary.

Resistive heater arrangement 332 may have different zones which may be individually controlled. By individually controlling different zones, the number of zones which are “on” at any given time may be controlled, thereby controlling the size of an effective cooling region. For example, zones that are not “on” may allow heat exchanger 304 to provide cooling, while zones that are “on” may compensate for cooling provided by heat exchanger 304 such that substantially no cooling is provided to reticle 312 in certain areas. That is, the size and shape of an effective cooling region of resistive heater arrangement 332 may be controlled by activating some zones and not others.

Resistive heater arrangement 332 may include a film, e.g., a polyimide film, which has multiple heaters. Resistive heater arrangement 332 may include individual heating elements formed on a face of a uniform piece of film, or may include individual heating elements formed on the faces of discrete pieces of film. Alternatively, resistive heater arrangement 332 may include copper that is printed onto heat exchanger 304.

FIG. 3B is a diagrammatic representation of a surface of resistive heater arrangement 332 which is arranged to be positioned over a top surface of reticle 312 in accordance with an embodiment of the present invention. Resistive heater arrangement 332 includes a resistive heater array 336 with multiple heating zones 340. The number of heating zones 340 included on array 336 may vary widely. Each heating zone 340 includes a heating element that is arranged to be individually controlled by a control arrangement 348. In one embodiment, the heating element associated with each zone 340 may be a thermoelectric chip. It should be appreciated, however, that any suitable heating element may be used to provide heating within each zone 340.

Control arrangement 348 cooperates with multiplexers 334a, 334b to activate individual zones 340. Control arrangement 348 may use information, e.g., information provided by sensors (not shown) or a computing arrangement (not shown), to determine which zones 340 to activate and which zones 340 not to activate. Control arrangement 348 may also calibrate current provided by a current supply 352 such that appropriate amounts of current are provided to zones 340. It should be appreciated that control arrangement 348 may include either an open loop control system or a closed loop control system. In one embodiment, thermistors may be embedded in zones 340 if control arrangement 348 is a closed loop control systems. Current supply 352 is arranged to provide the current which activates various zones 340, i.e., turns “on” the heating elements in appropriate zones 340. Zones 340 may generally be activated to effectively provide heat in zones 340 that correspond to areas of reticle 320 from which heat is not to be removed.

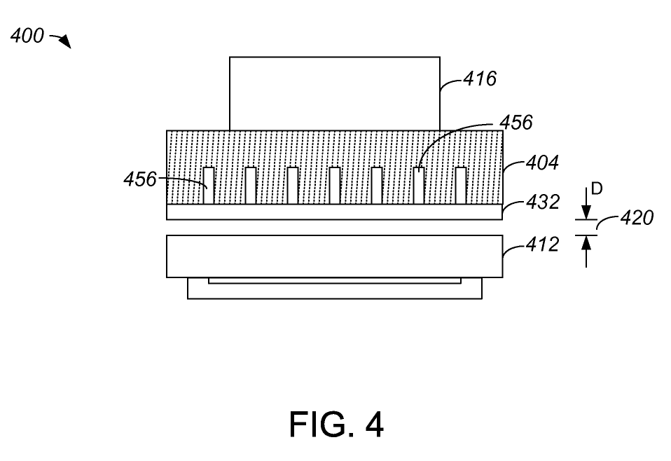

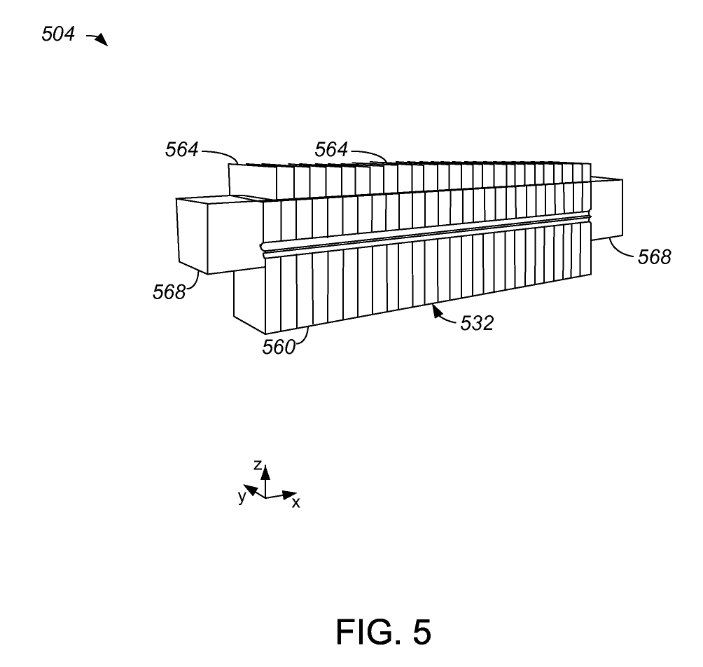

Referring next to FIG. 4, one system which includes a top side cooling arrangement with a resistive heater will be described in accordance with an embodiment of the present invention. FIG. 4 is a diagrammatic cross-sectional side-view representation of a system which includes a top side cooling arrangement with a resistive heater. A system 400 includes a heat exchanger 404 and a resistive heater 432 which are arranged to be moved using an actuator 416. Heat exchanger 404 and resistive heater 432 are arranged to be moved such that a surface of resistive heater 432 is at a distance ‘D’ 420 from, e.g., over, a reticle 412 when heat is to be transferred from reticle 412 to heat exchanger 404. In the described embodiment, heat exchanger 404 is not in contact with reticle 412 when heat is to be transferred from reticle 412 to heat exchanger 404.

Heat exchanger 404 may include vertical air gaps 456. Vertical air gaps 456 are arranged to substantially reduce any thermal coupling between zones (not shown), e.g., adjacent zones, associated with resistive heater 432. Portions of heat exchanger 404 between vertical air gaps 456 may essentially form posts onto which flexible heater and temperature sensor circuitry (not shown) coupled to resistive heater 432 may be substantially attached.

FIG. 5 is a perspective cut-away representation of a top side cooling device that includes a resistive heater array in accordance with an embodiment of the present invention. It should be appreciated that FIG. 5 depicts an example of a part of a top side cooling device, and that the design of a top side cooling device may vary widely. A top side cooling device 504 includes a heat exchanger 560 which may be a manifold that includes posts. A resistive heater array 532 is arranged on an underside of heat exchanger 560. Top side cooling device 504 also includes heater and temperature sensor circuitry 564. Such circuitry 564 may, in one embodiment, be flexible. Though not shown, it should be appreciated that top side cooling device 504 may also include various gaskets and fasteners.

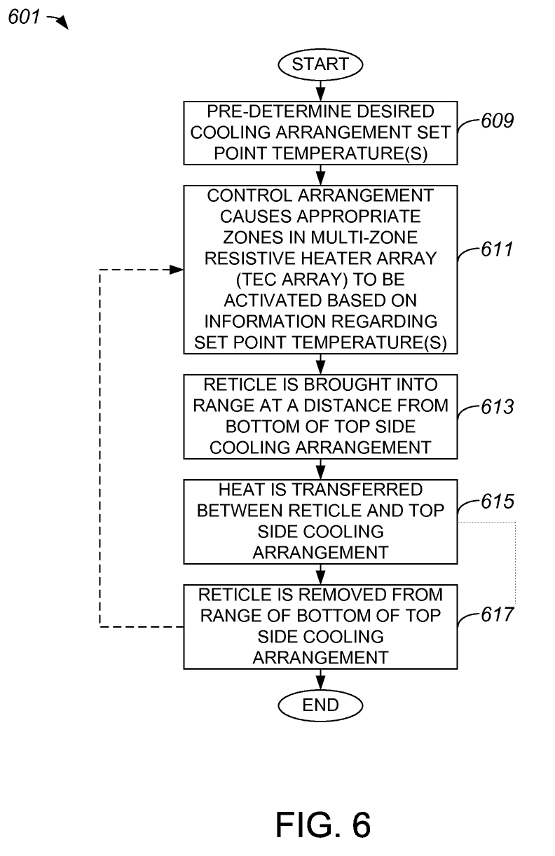

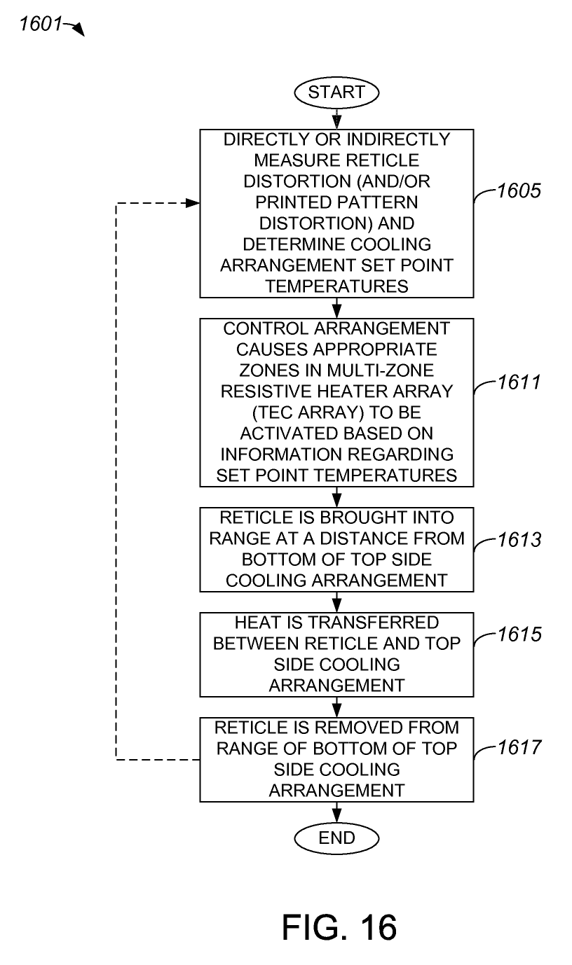

With reference to FIGS. 6 and 16, methods of providing top side cooling, e.g., top side conductive cooling, to a reticle will be described in accordance with embodiments of the present invention. FIG. 6 is a process flow diagram which illustrates a method of providing top side cooling to a reticle which includes closed-loop distortion control in accordance with an embodiment of the present invention. A method 601 of providing top side cooling to a reticle begins at step 609 in which at least one desired cooling arrangement set point temperature is pre-determined, as for example using a process such as simulation or testing. The set point temperature, or temperatures, may be set such that a desired reticle shape may be achieved.

In step 611, a control arrangement may cause appropriate zones in a multi-zone resistive heater array to be activated. The appropriate zones may be activated based on information regarding the set point temperature or temperatures The zones which are activated may effectively be selected based on the information regarding variations in the air gap. For example, if a zone is associated with an area of the reticle for which cooling is to be provided, the zone may not be activated, as the area is effectively to be cooled by the heat exchanger. On the other hand, if a zone is associated with an area of the reticle for which cooling is not to be provided, the zone may be activated to provide heat to counteract the cooling provided by the heat exchanger. When the zone provides heat, the zone may provide heat at a temperature that effectively compensates for the cooling provided by the heat exchanger such that no cooling to the reticle is effectively caused by that zone.

After appropriate zones in the multi-zone resistive heater array are activate, process flow moves to step 613 in which the reticle is brought into range of a top side cooling arrangement, e.g., device. The reticle may be brought into range such that a top surface of the reticle is at approximately a desired distance from a bottom of the top side cooling arrangement. In one embodiment, bringing the reticle into range may include moving the top side cooling arrangement, e.g., using a linear actuator, to a position over the reticle. It should be appreciated, however, that in lieu of moving the top side cooling arrangement, the reticle may instead be moved. In general, the top side cooling arrangement may be positioned substantially over the reticle during scanning or during a wafer exchange process.

Once the reticle is substantially positioned at approximately a desired distance from a bottom of the top side cooling arrangement, heat is transferred between the reticle and the top side cooling arrangement in step 615. The reticle is essentially removed in step 617 from the range of the bottom of the top side cooling arrangement, e.g., after the overall temperature of the reticle is considered to be acceptable and/or sufficient heat has been removed from appropriate parts of the reticle. Either the top side cooling arrangement may be moved or the reticle may be moved. In one embodiment, the top side cooling arrangement may be moved from a position over the reticle such that a reticle exchange process may occur. Upon removing the reticle from the range of the bottom of the top side cooling arrangement, the process of providing top side cooling to a reticle may be completed. Alternatively, if the top side of a reticle is to continue to be cooled, process flow may return to step 611 from step 617.

FIG. 16 is a process flow diagram which illustrates a method of providing top side cooling to a reticle which includes open-loop distortion control in accordance with an embodiment of the present invention. A method 1601 of providing top side cooling to a reticle begins at step 605 in which reticle distortion, and/or a printed pattern distortion, may be directly or indirectly measured. In addition to measuring reticle distortion, cooling arrangement set point temperatures may be determined. The set point temperature temperatures may be set such that a desired reticle shape may be achieved.

In step 1611, a control arrangement may cause appropriate zones in a multi-zone resistive heater array to be activated. The appropriate zones may be activated based on information regarding the set point temperature or temperatures. The zones which are activated may effectively be selected based on the information regarding variations in the air gap. For example, if a zone is associated with an area of the reticle for which cooling is to be provided, the zone may not be activated, as the area is effectively to be cooled by the heat exchanger. On the other hand, if a zone is associated with an area of the reticle for which cooling is not to be provided, the zone may be activated to provide heat to counteract the cooling provided by the heat exchanger. When the zone provides heat, the zone may provide heat at a temperature that effectively compensates for the cooling provided by the heat exchanger such that no cooling to the reticle is effectively caused by that zone.

After appropriate zones in the multi-zone resistive heater array are activate, process flow moves to step 1613 in which the reticle is brought into range of a top side cooling arrangement, e.g., device. The reticle may be brought into range such that a top surface of the reticle is at approximately a desired distance from a bottom of the top side cooling arrangement.

Once the reticle is substantially positioned at approximately a desired distance from a bottom of the top side cooling arrangement, heat is transferred between the reticle and the top side cooling arrangement in step 1615. Then, the reticle is essentially removed in step 1617 from the range of the bottom of the top side cooling arrangement, e.g., after the overall temperature of the reticle is considered to be acceptable and/or sufficient heat has been removed from appropriate parts of the reticle. Upon removing the reticle from the range of the bottom of the top side cooling arrangement, the process of providing top side cooling to a reticle may be completed. Alternatively, if the top side of a reticle is to continue to be cooled, process flow may return to step 1610 from step 1617.

While a multi-zone cooling system may be achieved using a liquid cooled heat exchanger and an array of resistive heaters as described above, a multi-zone cooling system may also be achieved in a variety of other ways. By way of example, an array of thermoelectric coolers or chips (TECs) may be used to provide a multi-zone cooling system. The TECs may be activated to generate differing amounts of heat based upon the amount of cooling desired to cool different areas of a cooling surface. Non-uniformity associated with a reticle may be substantially compensated for by changing the temperature for any one of the TECs in a multi-zone cooling system. That is, the temperature of a TEC may be adjusted such that the resultant temperature provided by a TEC and a heat exchanger is appropriate to compensate for the non-uniformity of a reticle. The temperature of a TEC may also be adjusted to intentionally distort a reticle, as for example to compensate for lens distortion.

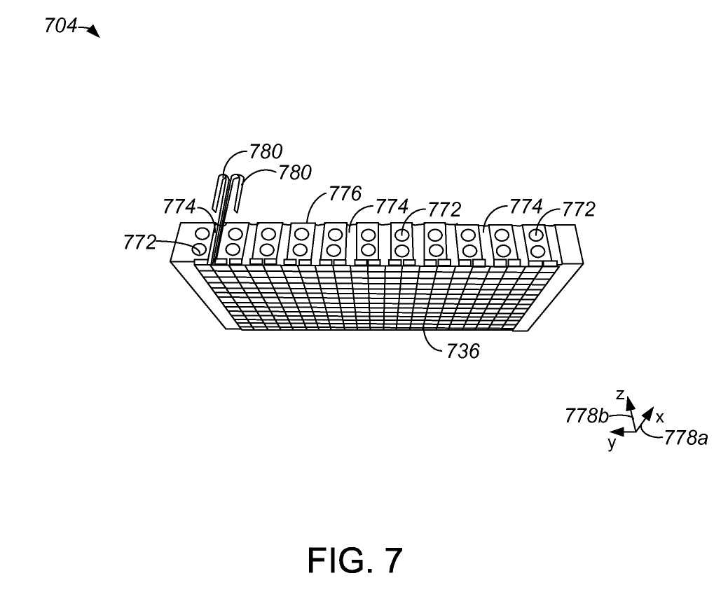

FIG. 7 is a perspective representation of a portion of a top side conductive cooling device which includes an array of TECs in accordance with an embodiment of the present invention. A top side conductive cooling device 704 includes a heat exchanger 776 and a thermo electric module (TEM) and sensor array 736. TEMs associated with array 736 typically include TECs. In general, array 736 may include any number of TECs or sensors.

Heat exchanger 776 may generally be formed from any suitable material. In one embodiment, heat exchanger 776 may be an aluminum heat exchanger. Heat exchanger 776 may include multiple channels 772 through which coolant, e.g., liquid coolant, is arranged to flow to essentially remove heat absorbed by heat exchanger 776. Channels 772 are arranged longitudinally substantially along an x-axis 778a.

Heat exchanger 776 also includes multiple openings 774. Openings 774, which may be arranged substantially along a z-axis 778b, are arranged to accommodate flex cables 780 and the like. By way of example, openings 774 may be arranged such that cable conduit (not shown) may pass therethrough. Further, openings 774 may allow air to flow to and from array 778a. For instance, openings 774 may be used to effectively locally intake TEC-cooled air. In general, a cover (not shown) is put over the topside of the heat exchanger 776, and is sealed to heat exchanger 776 and connected to a vacuum source (not shown) that provides a vacuum. The vacuum creates a lower pressure region on the topside of heat exchanger 776, and effectively causes air to be pulled in at a bottom side through openings 774, thereby reducing the effect of TEC-cooled air on ambient air.

It should be appreciated that there are generally multiple flex cables 780 which are attached all along heat exchanger 776. However, for ease of illustration, two representative flex cables 780 are shown. Further, flex cables 780 are arranged to be coupled to circuit boards (not shown), but circuit boards are not shown for ease of illustration. Circuit boards (not shown) generally include circuitry and/or logic that is configured to individually control TECs and sensors in array 736.

In one embodiment, circular rods (not shown), e.g., cylindrically-shaped plugs, may be positioned in at least some channels 772 to provide improved heat transfer efficiency. Such circular rods (not shown) may be sized such that coolant may flow through channels 772. That is, circular rods (not shown) may be sized such that space remains in channels 772 to enable coolant to flow around the circular rods.

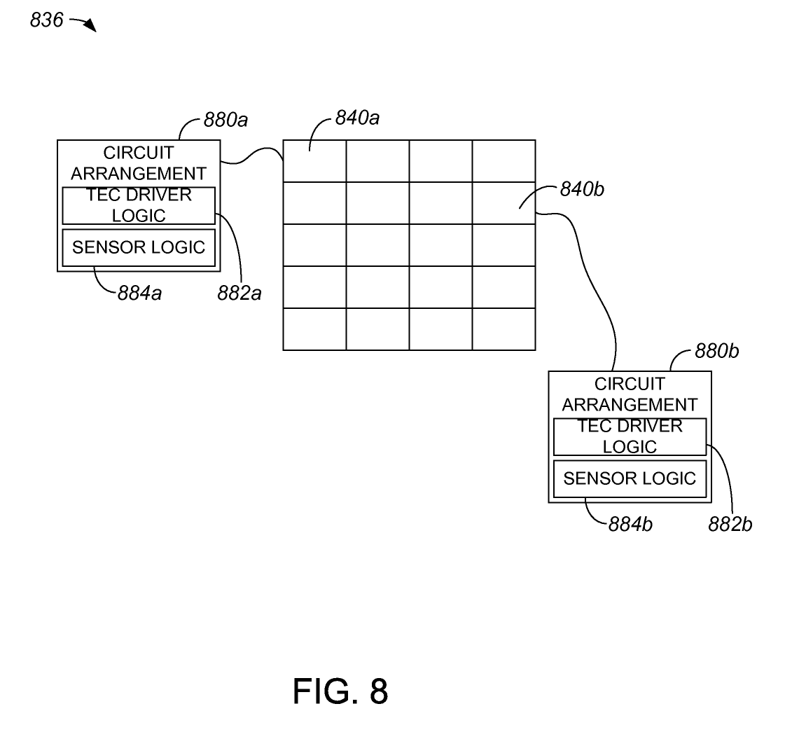

FIG. 8 is a diagrammatic representation of a TEC or sensor array which is a part of a top side conductive cooling device in accordance with an embodiment of the present invention. An array 836 includes multiple TEC or TEM assemblies 840a, 840b which are each coupled to a circuit arrangement 880a, 880b, respectively. The number of assemblies 840a, 840b may vary widely depending upon the requirements of a particular system. It should be appreciated that any number of assemblies 840a, 840b may be activated at any given time. Assemblies 840a, 840b may include embedded thermistors and/or other sensors that are arranged to obtain information associated with a cooling surface (not shown). For example, assemblies 840a, 840b may includes sensors arranged to obtain temperature information relating to the temperature of particular portions of a reticle (not shown) positioned at a distance from array 836. Such temperature information may be based on the temperatures of air associated with different areas of a gap between array 836 and the reticle (not shown).

In one embodiment, circuit arrangements 880a, 880b may include circuitry and logic that is arranged on a printed circuit board. The circuitry and logic may include, but are not limited to including, TEC driver logic 882a, 882b and sensor logic 884a, 884b. TEC driver logic 882a, 882b is arranged to enable assemblies 840a, 840b, respectively, to be activated as appropriate. Sensor logic 884a, 884b is arranged to enable the temperature associated with assemblies 840a, 840b, respectively, to be determined. Logic 882a, 882b, 884a, 884b may generally include hardware and/or software logic such as electrical circuitry, microcontrollers, and the like.

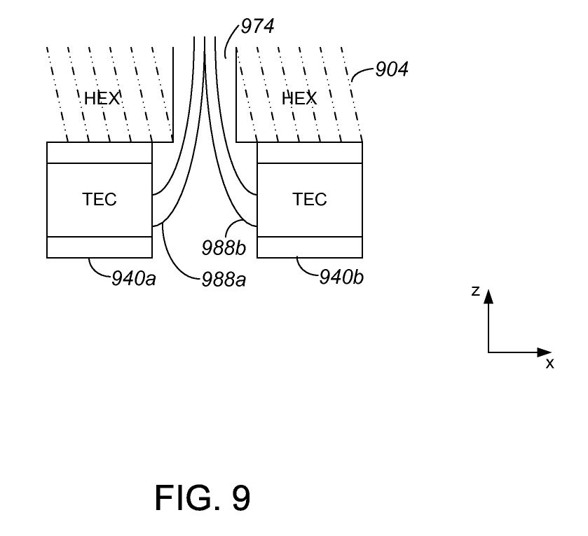

As previously mentioned, openings may exist in a heat exchanger to allow cables associated with TECs of a TEC array to pass through the heat exchanger, e.g., to circuit boards positioned on an opposite side of the heat exchanger. FIG. 9 is a diagrammatic representation of TECs in relation to a portion of a heat exchanger in accordance with an embodiment of the present invention. A heat exchanger 904 has an opening 974 defined therethrough. TECs 940a, 940b, which are a part of an overall array of TECs, are coupled to HEX 904. Cables 988a, 988b carry signals to and from TECs 940a, 940b, respectively. For example, cables 988a, 988b may carry power to TECs 940a, 940b, respectively, and may carry information obtained by sensors associated with TECs 940a, 940b, respectively. Such cables 988a, 988b may be flex cables.

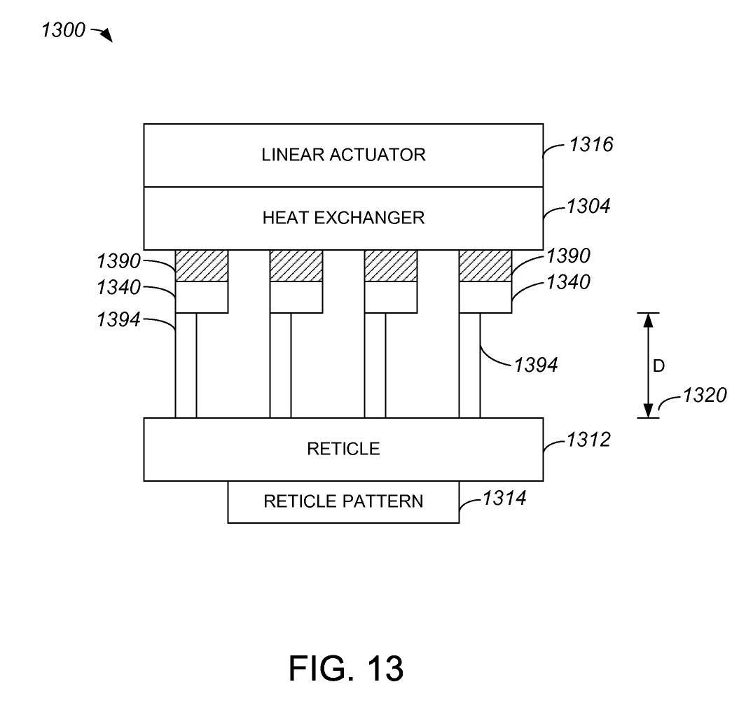

FIG. 13 is a block diagram representation of a system which includes a top side cooling arrangement configured to cool portions of a surface of a reticle by substantially direct contact in accordance with one embodiment of the present invention. A system 1300, which may be included as part of any suitable stage apparatus, includes a reticle 1312. Reticle 1312 is typically positioned on a stage (not shown), e.g., a reticle scanning stage, and includes a reticle pattern 1314.

To remove heat from reticle 1312, reticle 1312 may be positioned at a distance ‘D’ 1320 from heating elements 1340 associated with a heat exchanger 1304 such that heating elements 1340 obtain heat from reticle 1312 substantially without coming into contact with reticle 1312. Heating elements 1340 may be thermal elements such as resistive heaters or TECs.

Spacers 1394 may be configured to allow a desired distance to be maintained between heating elements 1340 and reticle 1312 when spacers 1394 are in substantially direct contact with reticle 1312. An array of compliant elements 1390, which, in addition to heat exchanger 1304 and heating elements 1340 may form an overall heat exchanger arrangement, allows heating elements 1340 to effectively conform to reticle 1312 when spacers 1394 are in contact with reticle 1312. In general, spacers 1394 may be formed from relatively rigid materials including, but not limited to including, polyetheretherkeytone (PEEK) or alumina,

System 1300 may include a linear actuator 1316 that may move heat exchanger 1304. Actuator 1316 may cooperate with spacers 1394 to position heating elements 1340 at a desired distance from reticle 1312 as needed to remove heat from reticle 1312, and to remove heating elements 1304 from the vicinity of reticle 1312 when heat removal is not needed.

It should be appreciated that although compliant elements 1390 are shown as being positioned between heat exchanger 1304 and heating elements 1340, compliant elements 1390 may instead, or additionally, positioned between heating elements 1340 and spacers 1394. Alternatively, in lieu of discrete compliant elements 1390, a single complaint element may be substantially shared by heating elements 1340.

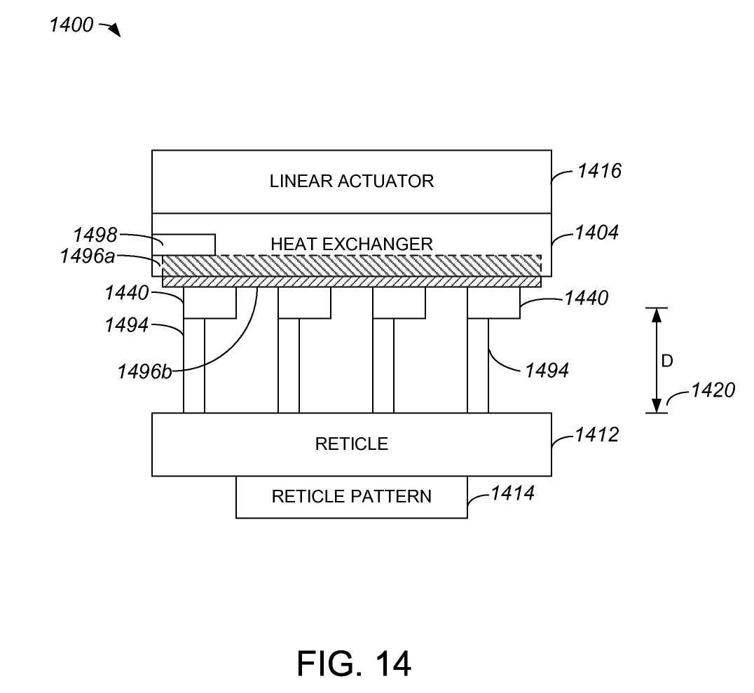

FIG. 14 is a block diagram representation of a system which includes a top side cooling arrangement configured to cool portions of a surface of a reticle by substantially direct contact in accordance with another embodiment of the present invention. A system 1400, which may be included as part of any suitable stage apparatus, includes a reticle 1412. Reticle 1412 is typically positioned on a stage (not shown), e.g., a reticle scanning stage, and includes a reticle pattern 1414.

Reticle 1412 may be positioned at a distance ‘D’ 1420 from heating elements 1440 associated with a heat exchanger 1404 such that heating elements 1440 may obtain heat from reticle 1412 substantially without coming into contact with reticle 1412. Heating elements 1440 may be thermal elements such as resistive heaters or TECs. It should be appreciated that heating elements 1440 and heat exchanger 1404 may be a part of an overall heat exchanger arrangement.

Spacers 1494 may be configured to allow a desired distance to be maintained between heating elements 1440 and reticle 1412 when spacers 1494 are in substantially direct contact with reticle 1412, e.g., during a heat exchange process. As show, heating elements 1440 may be directly coupled to spacers 1494.

A thermally conductive liquid or gas 1496a, which may be a part of heat exchanger 1404, and a flexible membrane 1496b cooperate to allow heating elements 1440 to conform to reticle 1412. Thermally conductive liquid or gas 1496a conducts heat between flexible membrane 1496b and heat exchanger 1404, and is arranged such that flexible membrane 1496b is not over constrained. Flexible membrane 1496b, which may be a part of an overall heat exchanger arrangement, is configured to maintain a relatively planar position of heating elements 1440, while also allowing heating elements 1440 to effectively conform to reticle 1412 when spacers 1494 are in contact with reticle 1412. A port 1498 in heat exchanger 1404 allows for an equalization of pressure associated with thermally conductive liquid or gas 1496a.

In one embodiment, flexible membrane 1496b may be a flexible electrical circuit. Such a flexible electrical circuit may be used to provide power to heating elements 1440, and/or to carry signals from integrated temperature sensors (not shown).

System 1400 may include a linear actuator 1416 that may move heat exchanger 1404. Actuator 1416 may cooperate with spacers 1494 to position heating elements 1440 at a desired distance from reticle 1412 as needed to remove heat from reticle 1412, and to remove heating elements 1404 from the vicinity of reticle 1412 when heat removal is not needed.

FIG. 15 is a block diagram representation of a spacer suitable for use with a top side cooling arrangement in accordance with an embodiment of the present invention. A spacer 1594 which comes into contact with a reticle 1512 may be integrated as a part of a heat exchanger, an adapter plate, or a thermal element. Alternatively, spacer 1594 may be associated with substantially separate structure that is coupled to a heat exchanger, an adapter plate, or a thermal element. As shown, spacer 1594 may be formed from asperities in the surface of a structure, e.g., a surface of a heat exchanger, and may essentially determine an effective gas film thickness.

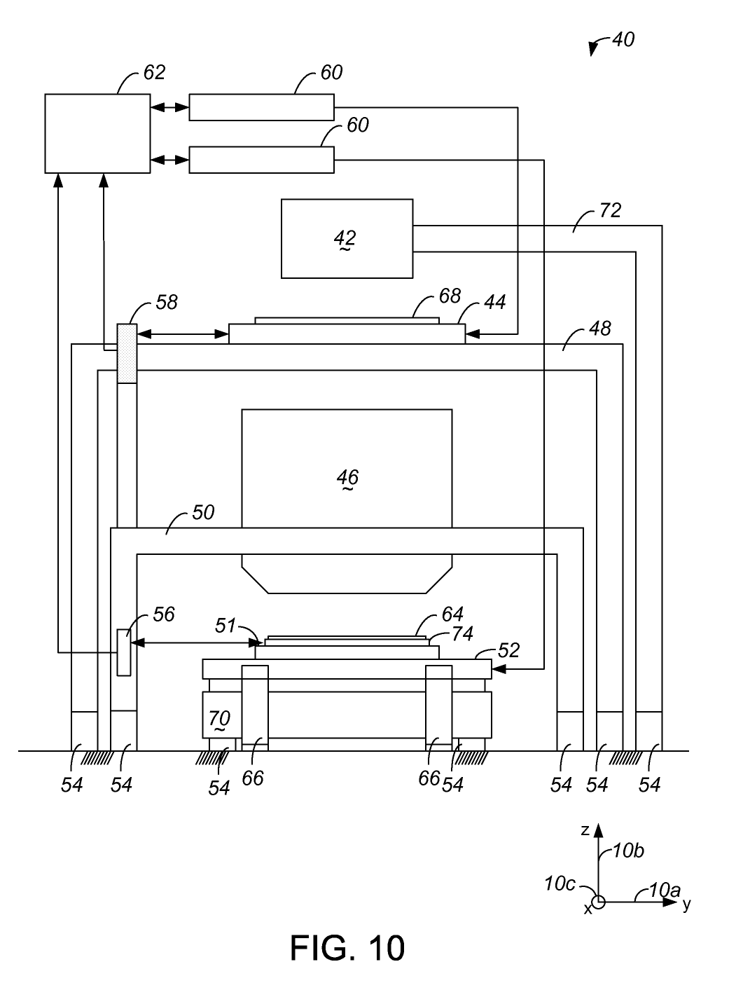

With reference to FIG. 10, a photolithography apparatus which may include a top side cooling device will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator. The planar motor which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In one described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which may include a coarse stage and a fine stage, or which may be a single, monolithic stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VU V) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open patent applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave mirror. Japan Patent Application Disclosure (Hei) No. 8-334695 published in the Official gazette for Laid-Open patent applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave mirror, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

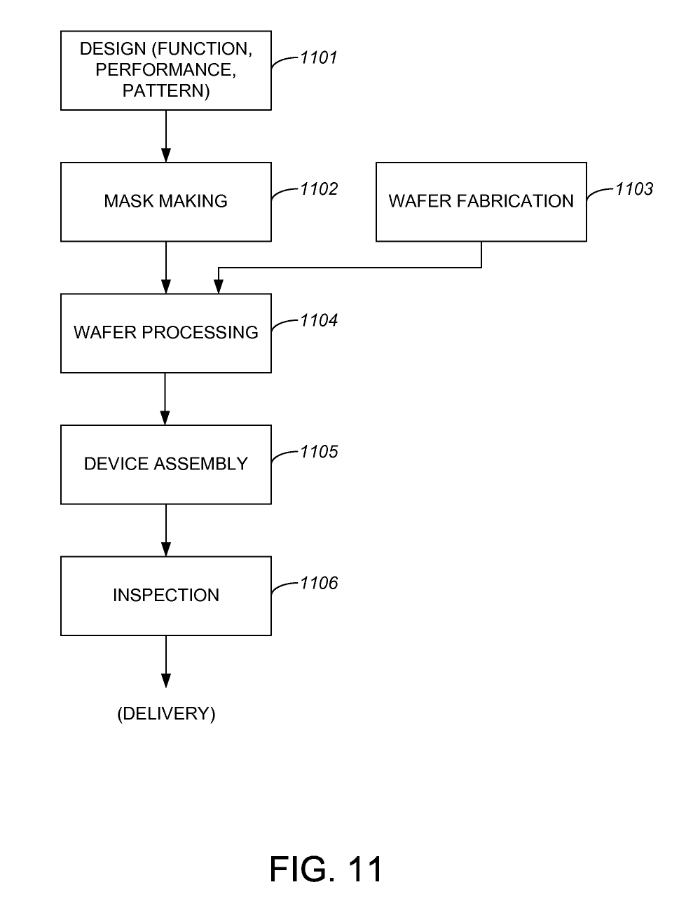

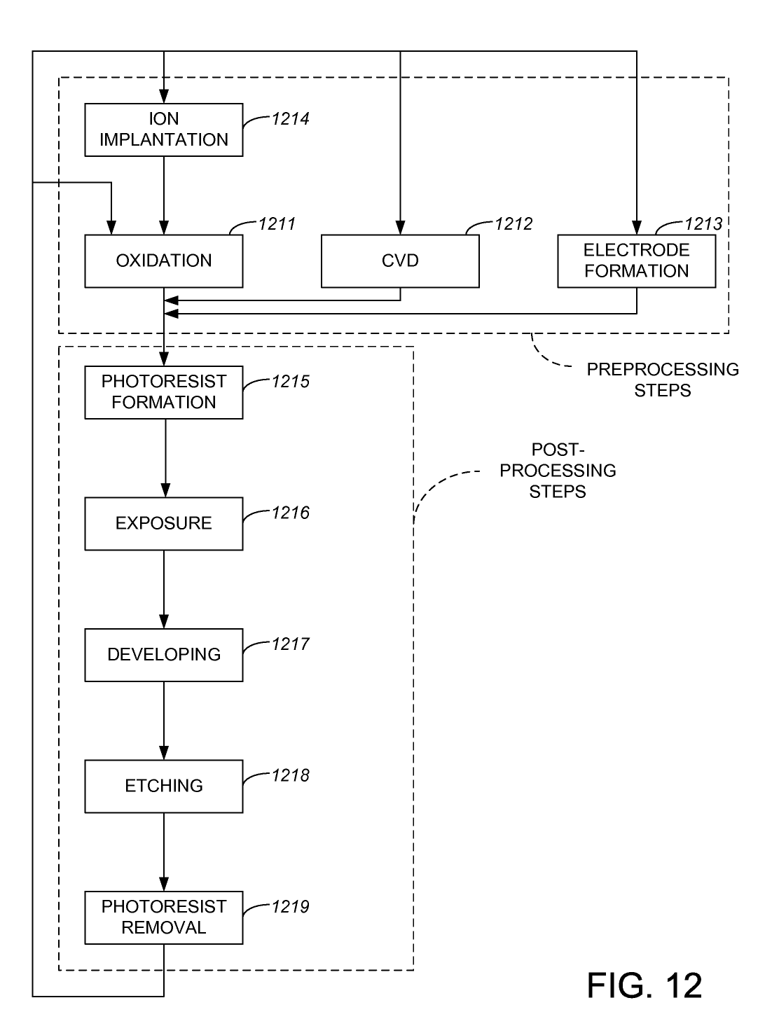

Further, semiconductor devices may be fabricated using systems described above, as will be discussed with reference to FIG. 11. FIG. 11 is a process flow diagram which illustrates the steps associated with fabricating a semiconductor device in accordance with an embodiment of the present invention. A process 1101 of fabricating a semiconductor device begins at step 1103 in which the function and performance characteristics of a semiconductor device are designed or otherwise determined. Next, in step 1105, a reticle or mask in which has a pattern is designed based upon the design of the semiconductor device. It should be appreciated that in a substantially parallel step 1109, a wafer is typically made from a silicon material. In step 1113, the mask pattern designed in step 1105 is exposed onto the wafer fabricated in step 1109. One process of exposing a mask pattern onto a wafer will be described below with respect to FIG. 12. In step 1117, the semiconductor device is assembled. The assembly of the semiconductor device generally includes, but is not limited to including, wafer dicing processes, bonding processes, and packaging processes. Finally, the completed device is inspected in step 1121. Upon successful completion of the inspection in step 1121, the completed device may be considered to be ready for delivery.

FIG. 12 is a process flow diagram which illustrates the steps associated with wafer processing in the case of fabricating semiconductor devices in accordance with an embodiment of the present invention. In step 1201, the surface of a wafer is oxidized. Then, in step 1205 which is a chemical vapor deposition (CVD) step in one embodiment, an insulation film may be formed on the wafer surface. Once the insulation film is formed, then in step 1209, electrodes are formed on the wafer by vapor deposition. Then, ions may be implanted in the wafer using substantially any suitable method in step 1213. As will be appreciated by those skilled in the art, steps 1201-1213 are generally considered to be preprocessing steps for wafers during wafer processing. Further, it should be understood that selections made in each step, e.g., the concentration of various chemicals to use in forming an insulation film in step 1205, may be made based upon processing requirements.

At each stage of wafer processing, when preprocessing steps have been completed, post-processing steps may be implemented. During post-processing, initially, in step 1217, photoresist is applied to a wafer. Then, in step 1221, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1225. Once the exposed wafer is developed, parts other than residual photoresist, e.g., the exposed material surface, may be removed by etching in step 1229. Finally, in step 1233, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, for an embodiment in which an adapter plate is used in conjunction with a heat exchanger, the configuration of the adapter plate may vary widely. While the adapter plate may have approximately the same area as a mask pattern on the surface of a reticle, the adapter plate may instead have a smaller area or a larger area than the mask pattern. Further, the surface of the adapter plate which is arranged to be positioned over a reticle, e.g., the surface that is closest to the reticle, may be arranged such that the distance between various parts of the surface of the adapter plate and a top surface of the reticle may vary. Alternatively, the surface of an adapter plate may include protrusions and indentations. Such protrusions and indentations may be arranged, in one embodiment, such that the distance between each part of the surface of the adapter plate and the top surface of the reticle may vary as needed to cool the reticle to a substantially uniform temperature.

In general, a heat exchanger may be any suitable heat exchanger. While an aluminum heat exchanger that is arranged to be cooled by liquid has generally been described, the materials from which a heat exchanger may be formed may vary widely. Additionally, the manner used to cool the heat exchanger may also vary widely.

A multi-zone cooling array, e.g., an array that includes TEMs, may be substantially coupled to a heat exchanger in a top side cooling arrangement using a variety of different methods. For example, a TEM may be bonded to a heat exchanger using an adhesive material such as epoxy.

In one embodiment, a surface of a multi-zone cooling array may be substantially flat or planar. To provide a substantially flat or planar surface on a multi-zone cooling array, lapping may be performed. For instance, a TEC or TEM array may be lapped to provide a relatively precise array flatness.

The number of channels in a heat exchanger may vary widely. The number of TECs associated with a TEC array may also vary depending upon the requirements of a particular multi-zone cooling system, as may the number of resistive sensors associated with a resistive heating array. In addition, the number of printed circuit boards that are used to provide logic and/or circuitry used in a multi-zone cooling system may vary widely without departing from the spirit or the scope of the present invention.

While a single heat exchanger has generally been shown as being suitable for use in providing top side cooling, any number of heat exchangers may be used. For example, the use of more than one heat exchanger may allow for the use of heat exchangers having different temperatures to cool different portions of a reticle. In one embodiment, different heat exchangers as well as portions of heat exchangers may be heated using a laser. By heating different heat exchangers and/or portions of heat exchangers to different temperatures, varying amounts of heat may be removed from different areas of a reticle as needed.

Any surface of a reticle may generally be cooled using a top side cooling system. In other words, the use of a top side cooling system which is configured to cool the reticle substantially without contacting any surface of the reticle is not limited to use in cooling a top surface of the reticle. For example, if a reticle does not use a pellicle, a bottom side or a patterned side of the reticle may be cooled conductively. Additionally, the use of a top side cooling system may cool substantially any object, and is not limited to providing cooling to a reticle.

A top side cooling system may be used as a heating system without departing from the spirit or the scope of the present invention. For instance, if it is desired to heat certain areas of a reticle while providing cooling to other areas of the reticle, appropriate resistive heaters or TECs may generate heat that is sufficient to heat the appropriate areas of the reticle. Certain areas of a reticle may be heated to provide intentional distortion of those areas in some embodiments.

The operations associated with the various methods of the present invention may vary widely. By way of example, steps may be added, removed, altered, combined, and reordered without departing from the spirit or the scope of the present invention.

The many features of the embodiments of the present invention are apparent from the written description. Further, since numerous modifications and changes will readily occur to those skilled in the art, the present invention should not be limited to the exact construction and operation as illustrated and described. Hence, all suitable modifications and equivalents may be resorted to as falling within the spirit or the scope of the present invention.

What is claimed is:

1. An apparatus for providing top side cooling to a reticle, the apparatus comprising:
a heat exchanger arrangement, the heat exchanger arrangement including a first surface, the first surface being arranged to facilitate heat transfer between the reticle and the heat exchanger arrangement, the heat transfer being arranged to cool at least some portions of the reticle; and
an actuator, the actuator being arranged to position the first surface of the heat exchanger arrangement at a distance over the reticle.

2. The apparatus of claim 1 wherein the heat exchanger arrangement includes a heat exchanger and a removable adapter plate, the removable adapter plate including the first surface.

3. The apparatus of claim 2 wherein the reticle includes a mask pattern having a pattern size, and wherein the removable adapter plate has a plate size, the plate size being approximately equal to the pattern size.

4. The apparatus of claim 3 wherein the adapter plate includes an array of protrusions and recesses arranged to affect a relative amount of cooling in individual zones.

5. The apparatus of claim 2 wherein the heat exchanger is a copper heat exchanger.

6. The apparatus of claim 1 wherein the heat exchanger arrangement includes a heat exchanger, a resistive heater array, and a controller arrangement, the resistive heater array being arranged to define the first surface, the controller arrangement being arranged to control the resistive heater array.

7. The apparatus of claim 6 wherein the resistive heater array includes a plurality of individually controlled zones and the controller arrangement is arranged to individually control each individually controlled zone of the plurality of individually controlled zones.

8. The apparatus of claim 7 wherein the plurality of individually controlled zones each includes an associated resistive element, and wherein each individually controlled zone of the plurality of individually controlled zones is arranged to be individually heated.

9. The apparatus of claim 8 wherein the plurality of individually controlled zones each includes a thermistor.

10. The apparatus of claim 1 wherein the heat exchanger arrangement includes a heat exchanger, at least one thermoelectric module (TEM), and a controller arrangement, the at least one TEM being arranged to define the first surface, the controller arrangement being arranged to control the at least one TEM.

11. The apparatus of claim 10 wherein the at least on TEM is an array of TEMS, and wherein each TEM of the array of TEMS is arranged to be individually controlled by the controller arrangement.

12. The apparatus of claim 11 wherein each TEM of the array of TEMS includes a thermistor.

13. The apparatus of claim 11 wherein each TEM of the array of TEMS is arranged to be individually heated and individually cooled relative to a temperature of the heat exchanger arrangement.

14. A stage apparatus comprising the apparatus of claim 1

15. An exposure apparatus comprising the stage apparatus of claim 14.

16. A wafer formed using the exposure apparatus of claim 15.

17. A cooling device suitable for providing top side cooling to a reticle, the cooling device comprising:
a heat exchanger, the heat exchanger being arranged to absorb heat associated with the reticle;
a sensing arrangement, the sensing arrangement being configured to obtain at least one temperature; and
a heating arrangement, the heating arrangement being coupled to the heat exchanger, the heating arrangement having a plurality of heating elements and a first arrangement, the first arrangement being arranged to individually control each heating element of the plurality of heating elements based on the at least one temperature.

18. The cooling device of claim 17 wherein the plurality of heating elements is a plurality of resistive heaters.

19. The cooling device of claim 18 wherein each resistive heater of the plurality of resistive heaters is arranged to be activated to compensate for cooling provided by the heat exchanger.

20. The cooling device of claim 17 wherein the heat exchanger is a liquid cooled heat exchanger.

21. The cooling device of claim 17 wherein the plurality of heating elements is a plurality of thermoelectric modules (TEMs).

22. The cooling device of claim 21 wherein each TEM of the plurality of TEMs is arranged to be activated to compensate for cooling provided by the heat exchanger.

23. The cooling device of claim 22 wherein the plurality of TEMs include a plurality of thermistors.

24. The cooling device of claim 20 wherein each TEM of the plurality of TEMs includes at least one sensor arranged to obtain temperature information associated with a cooling surface associated with the heating arrangement.

25. A stage apparatus comprising the cooling device of claim 17.

26. An exposure apparatus comprising the stage apparatus of claim 25.

27. A wafer formed using the exposure apparatus of claim 26.

28. A method for cooling a reticle, the method comprising:
identifying at least one zone associated with the reticle;
determining if a temperature associated with the at least one zone indicates that the at least one zone is to be cooled;
activating a first heating element associated with the at least one zone if it is determined that the at least one zone is not to be cooled, wherein activating the first heating element compensates for cooling provided by a heat exchanger; and
cooling the at least one zone using the heat exchanger if it is determined that the at least one zone is to be cooled.

29. The method of claim 28 wherein the first heating element is included in an array of heating elements, the array of heating elements and the heat exchanger being associated with a top side cooling device, the method further including:
positioning the top side cooling device at a distance over a top surface of the reticle, wherein positioning the top side cooling device at the distance over the top surface of the reticle includes maintaining a gap between the top side cooling device and the top surface of the reticle.

30. The method of claim 29 wherein the first heating element is a resistive heating element.

31. The method of claim 29 wherein the first heating element is a thermoelectric chip (TEC).

32. The method of claim 29 wherein determining if a temperature associated with the at least one zone indicates that the at least one zone is to be cooled includes determining the temperature in the gap that is associated with the at least one zone.

33. The method of claim 28 wherein activating the first heating element associated with the at least one zone if it is determined that the at least one zone is not to be cooled includes activating the first heating element to a first temperature, and wherein cooling the at least one zone using the heat exchanger if it is determined that the at least one zone is to be cooled includes activating the first heating element to a second temperature, the first temperature being higher than the second temperature.

34. The cooling device of claim 18 wherein each resistive heater of the plurality of resistive heaters is further arranged to be activated to distort the reticle to compensate for lens distortion.

35. The cooling device of claim 18 wherein each resistive heater of the plurality of resistive heaters is further arranged to be activated to distort the reticle to improve overlay associated with the reticle.
